(19) United States
(12) Patent Application Publication
(10) Pub. No.: US 2007/0119112 A1
(43) Pub. Date: May 31, 2007

(54) Storm door with external PVC surfaces and a steel core

(75) Inventors: Neil Goodman, Statesville, NC (US); Ping Han, Zhejiang (CN)

Correspondence Address: FOLEY AND LARDNER LLP;SUITE 500, 3000 K STREET NW, WASHINGTON, DC, 20007, US

(73) Assignee: Fine Eagle Building Materials Ltd.

(21) Appl. No.: 11/273,604

(22) Filed: Nov. 15, 2005

(51) Int. Cl. E06B 3/70

(52) U.S. Cl. 52/455

(57) ABSTRACT

A storm door includes first and second horizontal rail portions each having a first end and a second end and having an internal steel reinforcement portion extending substantially from the first end to the second end, and first and second vertical rail portions each having a first end and a second end and having an internal steel reinforcement portion extending substantially from the first end to the second end. The first and second horizontal rail portions and the first and second vertical rail portions are coupled together to form a substantially rectangular frame of the storm door. The first and second horizontal rail portions and the first and second vertical rail portions comprise external PVC surfaces.

### FIELD OF THE INVENTION

The present invention relates generally to storm doors and, more particularly, to a storm door having exterior PVC surfaces and a steel core.

### BACKGROUND OF THE INVENTION

Storm doors are used to provide an extra measure of thermal and moisture insulation at door openings of a building or home. A storm door can be located in the same door frame as a standard exterior door and positioned between the exterior door and the outside of the building or home to provide the thermal and moisture insulation.

Storm doors typically come in a variety of different designs. For example, a full-view storm door includes a window that makes up the entire door except for the frame. The full-view storm door can be designed to permit the window to be exchanged with a screen. A self-storing storm door typically has three sections: a fixed window pane, a fixed solid pane formed of the same material as and integral with the frame of the door, and a combination window/screen pane that can be slidably interchanged so that the window and/or the screen is present in the pane. The combination window/screen pane is usually placed between fixed window pane and the fixed solid pane. Other storm doors, such as a crossbuck door, simply have a fixed solid pane and a single window pane that can be interchanged with a screen.

In any design, it is desirable for the storm door to be strong and durable yet lightweight and inexpensive to manufacture. It would therefore be desirable to design a storm door that can satisfy these characteristics

### SUMMARY OF THE INVENTION

According to an aspect of the invention, a storm door includes first and second horizontal rail portions each having a first end and a second end and having an internal steel reinforcement portion extending substantially from the first end to the second end, and first and second vertical rail portions each having a first end and a second end and having an internal steel reinforcement portion extending substantially from the first end to the second end. The first and second horizontal rail portions and the first and second vertical rail portions are coupled together to form a substantially rectangular frame of the storm door. The first and second horizontal rail portions and the first and second vertical rail portions comprise external PVC surfaces.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a front elevational view of a storm door consistent with the present invention.

FIG. 2 is a sectional view taken along the lines A-A of FIG. 1.

FIG. 3 is a sectional view taken along the lines B-B of FIG. 1.

FIG. 4 is a sectional view taken along the lines C-C of FIG. 1.

FIG. 5 is a detailed cutaway view taken at the corner D of FIG. 1.

### DETAILED DESCRIPTION OF PREFERRED EMBODIMENTS

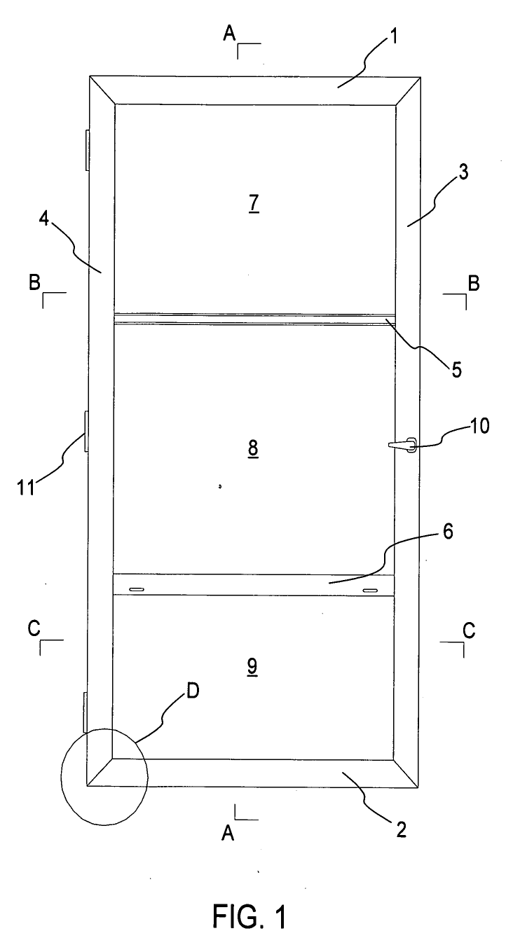

Referring now to FIG. 1, there is shown a front elevational view of a storm door consistent with the present invention. The storm door of FIG. 1 is an example of a self-storing storm door. It should be understood, however, that the storm door can be designed differently, such as a full view storm door or a crossbuck door, and that the following description with respect to a self-storing storm door is for exemplary purposes only. As shown in FIG. 1, the storm door includes a pair of horizontal sashes or rails 1,2 and a pair of vertical sashes or rails 3,4. The horizontal rail 1 is coupled at respective ends to a top end of the vertical sashes 3,4, and the horizontal rail 2 is coupled at respective ends to a bottom end of the vertical sashes 3,4. The combination of the horizontal rails 1,2 and the vertical sashes 3,4 forms a frame of the storm door of FIG. 1. The horizontal rails 1,2 and the vertical sashes 3,4 are preferably formed with PVC, although other materials may be used.

The storm door of FIG. 1 also includes a pair of sash muntins 5,6 that divide the storm door into three sections. The sash muntins 5,6 can be formed of PVC, aluminum, or some other lightweight material. A top section 7 preferably holds a window or glass pane. The window in top section 7 can be set in a fixed position. The middle section 8 preferably holds a window or glass pane and/or a screen. The window pane and screen may be slidable between the middle section 8 and the top section 7 so that either both or one is present in the middle section 8 at one time. It is also possible for the window pane and the screen to be respectively replaceable, i.e., one is popped or screwed into place at a time in the middle section 8. A bottom section 9 preferably holds a fixed PVC panel, although the panel can be formed from other materials.

The storm door of FIG. 1 further includes a handle 10 for locking, opening, and closing the storm door. A plurality of hinges 11 are used to mount the storm door in a door frame of a home or building. Although the handle 10 is shown on the right side and the hinges 11 are shown on the left side of the storm door, it should be understood that the handle 10 and the hinges 11 can be reversed. In either position, the handle 10 and the hinges 11 are preferably positioned on the opposite sides of the storm door.

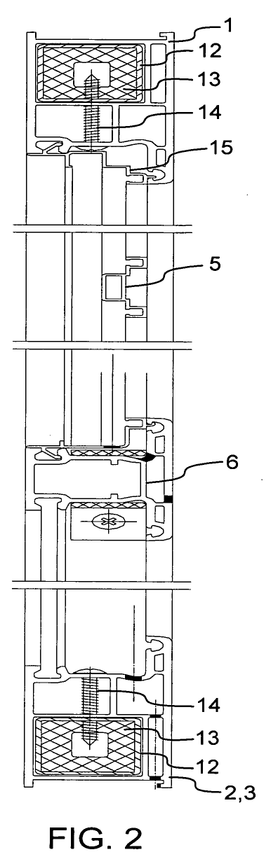

FIG. 2 is a sectional view taken along the lines A-A of FIG. 1. The sectional view of FIG. 2 shows details of the internal construction of the horizontal rails 1,2. In particular, the horizontal rails 1,2 each include an internal steel reinforcement portion 12. The internal steel reinforcement portion 12 is a relatively thin layer of steel and preferably has a substantially U-shaped or rectangular-shaped cross section. In addition, the internal steel reinforcement portion 12 preferably has a hollow core. The internal steel reinforcement portion 12 is formed to be in contact with or very nearly in contact with the exterior PVC portion of the horizontal rails 1,2.

In addition to the internal steel reinforcement portion 12, each of the horizontal rails 1,2 includes a part of a corner reinforcement portion 13. There is a part of the corner reinforcement portion 13 in each end of the horizontal rails 1,2. The corner reinforcement portions 13 are preferably formed from PVC or other sturdy plastic material. The corner reinforcement portions 13 are preferably formed to have a substantially rectangular or square-shaped cross-section with a hollow core. The thickness of the corner reinforcement portions 13 is preferably greater than the thickness of the steel reinforcement portions 12.

The exterior PVC portion of the horizontal rails 1,2 is coupled to the steel reinforcement portions 12 and the corner reinforcement portions 13 by screws 14. Although the coupling is shown as screws 14, it should be understood that other coupling elements as are known in the art can be used to connect the exterior PVC portion of the horizontal rails 1,2 to the steel reinforcement portions 12 and the corner reinforcement portions 13. FIG. 2 also shows an internal support section 15, which is preferably made of PVC or aluminum.

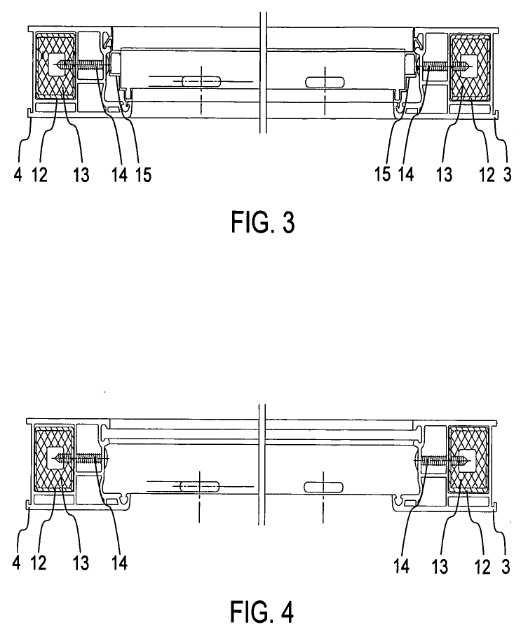

FIG. 3 is a sectional view taken along the lines B-B of FIG. 1. FIG. 4 is a sectional view taken along the lines C-C of FIG. 1. The sectional views of FIGS. 3 and 4 show details of the internal design of the vertical rails 3,4. In particular, like the horizontal rails 1,2, the vertical rails 3,4 each include an internal steel reinforcement portion 12 preferably having the same thickness and design as that of the horizontal rails 1,2. The vertical rails 3,4 also include a part of a corner reinforcement portion 13 positioned in each end of the vertical rails 3,4. The exterior PVC portion of the vertical rails 3,4 is also coupled to the steel reinforcement portions 12 and the corner reinforcement portions 13 by screws 14. FIG. 3 also shows an internal support section 15, which is preferably made of PVC or aluminum.

In general, the internal steel reinforcement portions 12 provide stability to the storm doors. More specifically, the internal steel reinforcement portions and serve as a core

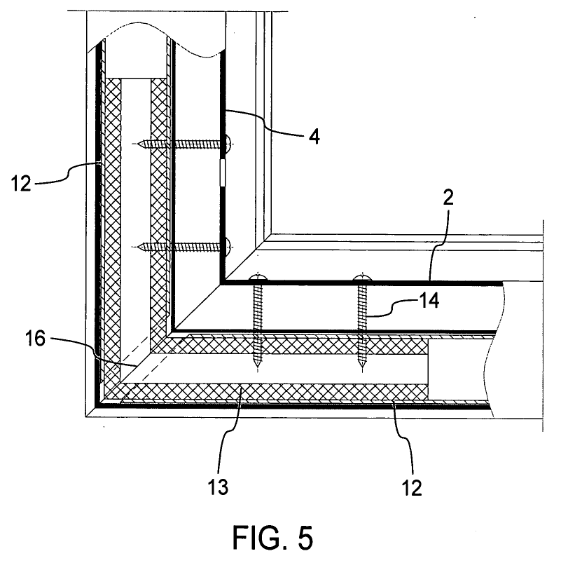

FIG. 5 shows a detailed cutaway view of a corner portion of the storm door including a complete corner reinforcement portion 13. The corner shown in FIG. 5 is for the corner joining the horizontal rail 2 and the vertical rail 4. It should be understood, however, that the view shown in FIG. 5 is applicable to each of the other corners of the storm door.

As shown in FIG. 5, a part of the corner reinforcement portion 13 is present in the horizontal rail 2, and a part of the corner reinforcement portion 13 is present in the vertical rail 4. As also shown in FIG. 5, the ends of the exterior PVC portions of the horizontal rail 2 and the vertical rail 4 are mitered at 45 degree angles such that, when the respective ends are joined together, the horizontal rail 2 and the vertical rail 4 form a 90 degree angle. The ends of the corner reinforcement portions 13 in the horizontal rail 2 and the vertical rail 4 are likewise formed in such a manner. As shown in FIG. 5, the corner reinforcement portions 13 extend only part way into the horizontal rail 2 and the vertical rail 4. In an alternative embodiment, it is possible for the corner reinforcement portions 13 to extend the entire length or a greater portion of the horizontal rail 2 and the vertical rail 4.

FIG. 5 also shows that the internal steel reinforcement portions 12 extend substantially to the end of the horizontal rail 2 and the vertical rail 4, but not as far as the corner reinforcement portions 13. The internal steel reinforcement portions 12 preferably extend as close as possible to the end of the horizontal rail 2 and the vertical rail 4 to provide additional support for them. Two pairs of screws 14 are positioned adjacent to the corner of the storm door. The two pairs of screws 14 near each corner of the storm door can be the only elements coupling the exterior PVC portion of the horizontal rails 1,2 and vertical rails 3,4 to the respective steel reinforcement portions 12 and corner reinforcement portions 13. Alternatively, additional screws 14 can be used for the coupling in each rail.

The horizontal rail 2 and the vertical rail 4 are preferably coupled together at the respective exterior PVC portions and at the respective corner reinforcement portions 13. The coupling can be made, for example, with a PVC weld. Alternatively, the rails can be coupled together with a metal bracket or other couplings as are known in the art.

The foregoing description of preferred embodiments of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to make and use the invention in various embodiments and with various modifications suited to the particular use contemplated. It is intended that the scope of the invention be defined by the claims appended hereto and their equivalents.

What is claimed is:

1. A storm door, comprising:
first and second horizontal rail portions each having a first end and a second end and having an internal steel reinforcement portion extending substantially from the first end to the second end; and
first and second vertical rail portions each having a first end and a second end and having an internal steel reinforcement portion extending substantially from the first end to the second end,
wherein the first and second horizontal rail portions and the first and second vertical rail portions are coupled together to form a substantially rectangular frame of the storm door, and
wherein the first and second horizontal rail portions and the first and second vertical rail portions are comprise external PVC surfaces.

2. A storm door according to claim 1, wherein the first horizontal rail portion is coupled at its first end to the first end of the first vertical rail portion and coupled at its second end to the first end of the second vertical rail portion, and
wherein the second horizontal rail portion is coupled at its first end to the second end of the first vertical rail portion and coupled at its second end to the second end of the second vertical rail portion

3. A storm door according to claim 2, wherein each end of the first and second horizontal rail portions and the first and second vertical rail portions is mitered such that coupling any one of the first and second horizontal rail portions with any one of the first and second vertical rail portions forms a substantially ninety degree angle.

4. A storm door according to claim 2, wherein the first and second horizontal rail portions and the first and second vertical rail portions are coupled together by metal brackets.

5. A storm door according to claim 1, wherein each of the internal steel reinforcement portions has a hollow core.

6. A storm door according to claim 5, wherein each of the internal steel reinforcement portions has a substantially rectangular cross-section.

7. A storm door according to claim 5, wherein each of the internal steel reinforcement portions has a substantially U-shaped cross-section.

8. A storm door according to claim 1, further comprising a plurality of connectors that couple the first and second horizontal rail portions and the first and second vertical rail portions to their respective internal steel reinforcement portions.

9. A storm door according to claim 8, wherein the connectors comprise screws.

10. A storm door according to claim 9, wherein the screws are positioned adjacent to each corner of the rectangular frame of the storm door.

11. A storm door according to claim 1, further comprising a plurality of corner reinforcement portions, each corner reinforcement portion being positioned in a respective corner of the storm door and being positioned substantially inside of the internal steel reinforcement portions.

12. A storm door according to claim 11, wherein the corner reinforcement portions are composed of PVC.

13. A storm door according to claim 11, wherein a thickness of the corner reinforcement portions is greater than a thickness of the internal steel reinforcement portions.

14. A storm door according to claim 11, wherein the corner reinforcement portions have a substantially rectangular cross-section and a hollow core.

15. A storm door according to claim 11, wherein the first and second horizontal rail portions and the first and second vertical rail portions are coupled together by welding together respective corner reinforcement portions.

16. A storm door according to claim 11, wherein the first and second horizontal rail portions and the first and second vertical rail portions are coupled together by connecting respective corner reinforcement portions with brackets.
